(19) United States
(12) Patent Application Publication
(10) Pub. No.: US 2022/0336896 A1
(43) Pub. Date: Oct. 20, 2022

(54) BATTERY CONFIGURATIONS WITH CORROSION BARRIER

(71) Applicant: Apple Inc., Cupertino, CA (US)

(72) Inventors: Kyle Tse, Fremont, CA (US); Susheel Teja Gogineni, Santa Clara, CA (US); Shawn G. Fink, Sunnyvale, CA (US); Yanning Song, Cupertino, CA (US)

(73) Assignee: Apple Inc., Cupertino, CA (US)

(21) Appl. No.: 17/714,752

(22) Filed: Apr. 6, 2022

Related U.S. Application Data
(60) Provisional application No. 63/176,475, filed on Apr. 19, 2021.

(51) Int. Cl. H01M 50/145; H01M 50/116; H01M 50/536

(52) U.S. Cl. CPC H01M 50/145; H01M 50/116; H01M 50/536

(57) ABSTRACT

Rechargeable battery cells according to embodiments of the present technology may include a housing having a first conductive segment operable at anode potential. The housing may include a second conductive segment operable at cathode potential. The housing may include a gasket positioned between the first conductive segment and the second conductive segment and configured to hermetically seal the housing. The cells may include an electrode stack including an anode. The anode may include an anode tab electrically coupled with the first conductive segment of the housing. The electrode stack may include a cathode. The cathode may include a cathode tab electrically coupled with the second conductive segment of the housing. The cells may include a barrier material disposed between the cathode tab and the second conductive segment of the housing. The cathode tab may be electrically coupled with the second conductive segment of the housing through the barrier material.

### CROSS-REFERENCES TO RELATED APPLICATIONS

This application claims the benefit of U.S. Provisional Application Ser. No. 63/176,475, filed Apr. 19, 2021; the disclosures of which is hereby incorporated by reference in its entirety for all purposes.

### TECHNICAL FIELD

The present technology relates to batteries. More specifically, the present technology relates to battery component configurations.

### BACKGROUND

Batteries are used in many devices. As increased energy density is sought in reduced form factors, device configurations and coupling may cause challenges.

### SUMMARY

Rechargeable battery cells according to some embodiments of the present technology may include a housing having a first conductive segment operable at anode potential. The housing may include a second conductive segment operable at cathode potential. The housing may include a gasket positioned between the first conductive segment and the second conductive segment and configured to hermetically seal the housing. The cells may include an electrode stack including an anode. The anode may include an anode tab electrically coupled with the first conductive segment of the housing. The electrode stack may include a cathode. The cathode may include a cathode tab electrically coupled with the second conductive segment of the housing. The cells may include a barrier material disposed at least partially between the cathode tab and the second conductive segment of the housing. The cathode tab may be electrically coupled with the second conductive segment of the housing through the barrier material.

In some embodiments, the second conductive segment may be stainless steel. The barrier material may be characterized by an annular shape. The cathode tab may be coupled with the second conductive segment of the housing at an aperture defining an inner annular radius of the annular shape of the barrier material. The aperture may be characterized by an elliptical or rectangular shape. The cathode tab may be characterized by a first surface coupled with the second conductive segment of the housing, and a second surface opposite the first surface. The rechargeable battery cell may include a first insulative material in contact with the first surface of the cathode tab and extending partially along the first surface of the cathode tab. The first insulative material may be positioned adjacent the barrier material. The cells may include a second insulative material in contact with the second surface of the cathode tab and extending partially along the second surface of the cathode tab. The second insulative material may extend beyond lateral edges of the cathode tab. the second insulative material may contact the barrier material externally to the cathode tab. The second insulative material may cover the aperture defining the inner annular radius of the barrier material. The second insulative material may be characterized by an end region shaped to cover the aperture defining the inner annular radius of the barrier material. The barrier material, the first insulative material, and the second insulative material may each include a similar material. The similar material may be an adhesive polymeric material.

Some embodiments of the present technology may encompass rechargeable battery cells. The cells may include a button-cell housing. The housing may include a first conductive segment, a second conductive segment, and a gasket positioned between the first conductive segment and the second conductive segment and configured to seal the button-cell housing. The cells may include an electrode stack including an anode and a cathode. The cathode may include a cathode tab physically and electrically coupled with the second conductive segment of the housing. The cells may include a barrier material disposed at least partially between the cathode tab and the second conductive segment of the button-cell housing. The cathode tab may extend through the barrier material and physically and electrically couples with the second conductive segment of the housing.

In some embodiments, the barrier material may be a material comprising an adhesive surface. The adhesive surface may extend in contact with the second conductive segment of the button-cell housing. The barrier material may be characterized by an annular shape. The cathode tab may be coupled with the second conductive segment of the housing at an aperture defining an inner annular radius of the annular shape of the barrier material. The cathode tab may be characterized by a first surface coupled with the second conductive segment of the housing, and a second surface opposite the first surface. The rechargeable battery cell may include a first insulative material in contact with the first surface of the cathode tab and extending partially along the first surface of the cathode tab. The first insulative material may be a material including an adhesive surface. The adhesive surface may extend in contact with the cathode tab. A surface of the first insulative material opposite the adhesive surface may extend in contact with the barrier material. The cells may include a second insulative material in contact with the second surface of the cathode tab and extending partially along the second surface of the cathode tab. The second insulative material may be a material including an adhesive surface. The adhesive surface may extend in contact with the cathode tab. An edge region of the adhesive surface may contact the barrier material.

Some embodiments of the present technology may encompass rechargeable battery cells. The cells may include a housing including a first conductive segment operable at anode potential, a second conductive segment operable at cathode potential, and a gasket positioned between the first conductive segment and the second conductive segment and configured to hermetically seal the housing. The cells may include an electrode stack including an anode. The anode may include an anode tab electrically coupled with the first conductive segment of the housing. The electrode stack may include a cathode. the cathode may include a cathode tab electrically coupled with the second conductive segment of the housing. The cathode tab may be characterized by a first surface coupled with the second conductive segment of the housing, and a second surface opposite the first surface. The cells may include a barrier material encompassing the cathode tab and disposed between the electrode stack and the second conductive segment of the housing. The cathode tab may be electrically coupled with the second conductive segment of the housing through the barrier material.

Such technology may provide numerous benefits over conventional technology. For example, the present batteries may reduce corrosion of conductive housing components. Additionally, the batteries may facilitate electrode connections within the battery enclosure incorporating barrier materials. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic cross-sectional view of battery cell materials according to some embodiments of the present technology.

FIG. 2 shows a schematic cross-sectional elevation view of a battery according to some embodiments of the present technology.

FIG. 3A shows a schematic view of battery materials according to some embodiments of the present technology.

FIG. 3B shows a schematic view of battery materials according to some embodiments of the present technology.

FIG. 3C shows a schematic view of battery materials according to some embodiments of the present technology.

FIG. 4 shows a schematic cross-sectional elevation view of battery materials according to some embodiments of the present technology.

FIG. 5 shows a schematic view of battery materials according to some embodiments of the present technology.

FIG. 6 shows a schematic view of an insulative material according to some embodiments of the present technology.

FIG. 7 shows a schematic view of an insulative material according to some embodiments of the present technology.

FIG. 8 shows a schematic cross-sectional elevation view of battery materials according to some embodiments of the present technology.

Several of the figures are included as schematics. It is to be understood that the figures are for illustrative purposes, and are not to be considered of scale or proportion unless specifically stated to be of scale or proportion. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Batteries, battery cells, and more generally energy storage devices, are used in a host of different systems. In many devices, the battery cells may be designed with a balance of characteristics in mind. For example, including larger batteries may provide increased usage between charges, however, the larger batteries may require larger housing, or increased space within the device. As device designs and configurations change, especially in efforts to reduce device sizes, the available space for additional battery components may be constrained. These constraints may include restrictions in available volume as well as the geometry of such a volume.

Button-cell batteries often may be primary or non-rechargeable batteries. Primary batteries may allow increased thickness of electrodes, as reversing the electrochemical process may not be performed. For lithium-ion or other rechargeable battery designs, challenges may be presented that may lead conventional technologies away from rechargeable designs. For example, button-cell batteries often include conductive housings that operate at anode and cathode potential. Some materials may include stainless steel, among a number of other materials. Electrolytes of lithium-ion batteries may include materials that can facilitate corrosion reactions for stainless steel. This corrosion may be exacerbated when there is line-of-sight between the battery cell electrodes and the housing. Accordingly, many conventional technologies avoid these materials, or accept reduced lifetime due to corrosion effects.

The present technology may overcome these issues, however, by providing a configuration that limits or prevents any direct line-of-sight between the electrode stack of the battery cell and the housing operating at cathode potential. By incorporating an additional barrier material along the cathode housing, and which accommodates a cathode tab, corrosion within a battery cell may be reduced or eliminated. After illustrating an exemplary cell that may be used in embodiments of the present technology, the present disclosure will describe battery designs having components and a configuration for use in a variety of devices in which battery cells may be used.

Although the remaining portions of the description will reference lithium-ion batteries, it will be readily understood by the skilled artisan that the technology is not so limited. The present techniques may be employed with any number of battery or energy storage devices, including other rechargeable and primary battery types, as well as secondary batteries, or electrochemical capacitors. Moreover, the present technology may be applicable to batteries and energy storage devices used in any number of technologies that may include, without limitation, phones and mobile devices, watches, glasses, bracelets, anklets, and other wearable technology including fitness devices, handheld electronic devices, laptops and other computers, motor vehicles and other transportation equipment, as well as other devices that may benefit from the use of the variously described battery technology.

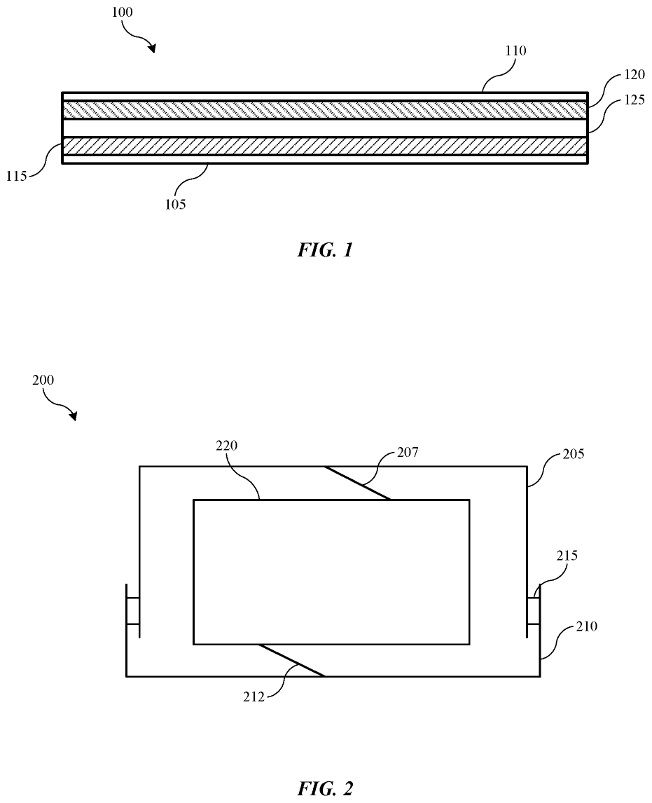

FIG. 1 depicts a schematic cross-sectional view of materials for an energy storage device or battery cell 100 according to embodiments of the present technology. Battery cell 100 may be or include an electrode stack, and may be one of a number of stacks coupled together to form a battery structure. As would be readily understood, the layers are not shown at any particular scale, and are intended merely to show the possible layers of cell material of one or more cells that may be incorporated into an energy storage device. In some embodiments, as shown in FIG. 1, battery cell 100 includes a first current collector 105 and a second current collector 110. In embodiments one or both of the current collectors may include a metal or a non-metal material, such as a polymer or composite that may include a conductive material. The first current collector 105 and second current collector 110 may be different materials in embodiments. For example, in some embodiments the first current collector 105 may be a material selected based on the potential of an anode active material 115, and may be or include copper, stainless steel, or any other suitable metal, as well as a non-metal material including a polymer. The second current collector 110 may be a material selected based on the potential of a cathode active material 120, and may be or include aluminum, stainless steel, or other suitable metals, as well as a non-metal material including a polymer. In other words, the materials for the first and second current collectors can be selected based on electrochemical compatibility with the anode and cathode active materials used, and may be any material known to be compatible.

In some instances the metals or non-metals used in the first and second current collectors may be the same or different. The materials selected for the anode and cathode active materials may be any suitable battery materials operable in rechargeable as well as primary battery designs. For example, the anode active material 115 may be silicon, graphite, carbon, a tin alloy, lithium metal, a lithium-containing material, such as lithium titanium oxide, or other suitable materials that can form an anode in a battery cell. Additionally, for example, the cathode active material 120 may be a lithium-containing material. In some embodiments, the lithium-containing material may be a lithium metal oxide, such as lithium cobalt oxide, lithium manganese oxide, lithium nickel manganese cobalt oxide, lithium nickel cobalt aluminum oxide, or lithium titanate, while in other embodiments the lithium-containing material can be a lithium iron phosphate, or other suitable materials that can form a cathode in a battery cell.

The first and second current collectors as well as the active materials may have any suitable thickness. A separator 125 may be disposed between the electrodes, and may be a polymer film or a material that may allow lithium ions to pass through the structure while not otherwise conducting electricity. Active materials 115 and 120 may additionally include an amount of electrolyte in a completed cell configuration, which may be absorbed within the separator 125 as well. The electrolyte may be a liquid including one or more salt compounds that have been dissolved in one or more solvents. The salt compounds may include lithium-containing salt compounds in embodiments, and may include one or more lithium salts including, for example, lithium compounds incorporating one or more halogen elements such as fluorine or chlorine, as well as other non-metal elements such as phosphorus, and semimetal elements including boron, for example.

In some embodiments, the salts may include any lithium-containing material that may be soluble in organic solvents. The solvents included with the lithium-containing salt may be organic solvents, and may include one or more carbonates. For example, the solvents may include one or more carbonates including propylene carbonate, ethylene carbonate, ethyl methyl carbonate, dimethyl carbonate, diethyl carbonate, and fluoroethylene carbonate. Combinations of solvents may be included, and may include for example, propylene carbonate and ethyl methyl carbonate as an exemplary combination. Any other solvent may be included that may enable dissolving the lithium-containing salt or salts as well as other electrolyte component, for example, or may provide useful ionic conductivities, such as greater than or about 5⁻¹⁰ mS/cm.

Although illustrated as single layers of electrode material, battery cell 100 may be any number of layers. Although the cell may be composed of one layer each of anode and cathode material as sheets, the layers may also be formed into any form such that any number of layers may be included in battery cell 100. For embodiments which include multiple layers, tab portions of each anode current collector may be coupled together, as may be tab portions of each cathode current collector, although one or more of the current collectors may be a continuous current collector material as will be described below. Once the cell has been formed, a pouch, housing, or enclosure may be formed about the cell to contain electrolyte and other materials within the cell structure. Terminals may extend from the enclosure to allow electrical coupling of the cell for use in devices, including an anode and cathode terminal. The coupling may be directly connected with a load that may utilize the power, and in some embodiments the battery cell may be coupled with a control module that may monitor and control charging and discharging of the battery cell. When multiple cells are stacked together, electrode terminals at anode potential may be coupled together, as may be electrode terminals at cathode potential. These coupled terminals may then be connected with the terminals on the enclosure as noted above.

The structure of battery cell 100 may also illustrate the structure of a solid-state battery cell, which may include anode and cathode materials as well as current collectors as noted previously. A difference between the solid-state design and liquid-electrolyte design previously explained is that in addition to not including electrolyte, separator 125 may be characterized by different materials, although the materials may be characterized by similar properties, such as the ability to pass ions through the material while limiting the passage of electrons. In solid-state configurations, the anode and cathode materials may be any of the materials noted above, as well as additional materials operable as electrode active materials within a solid-state cell. For example, anode materials may include graphene or carbon materials, lithium metal, titanium-containing materials, lithium alloys, as well as other anode-compatible materials. Cathode materials may include lithium-containing oxides or phosphates, as well as other cathode-compatible materials. The inter-electrode material, which may also be noted as 125, may include an electron-blocking material, such as a separator, as well as or alternatively, a solid electrolyte material having ion mobility. Glass materials and ceramics may be used, as well as polymeric materials that may include ion-conducting additives, such as lithium salts. In any instance where the word separator is used, it is to be understood as encompassing both separators and solid electrolytes, which may or may not incorporate separator materials. FIG. 1 is included as an exemplary cell that may be incorporated in batteries according to the present technology. It is to be understood, however, that any number of battery and battery cell designs and materials that may include charging and discharging capabilities similarly may be encompassed by or incorporated with the present technology.

FIG. 2 shows a schematic cross-sectional elevation view of a battery cell 200 according to some embodiments of the present technology. Battery cell 200 may illustrate a button-cell battery housing, although it is to be understood that any number of other housing configurations are similarly encompassed by the present technology, in which electrode stacks as described throughout the disclosure may accommodate a number of configurations and geometries beyond the non-limiting examples shown. Battery cell 200 may include an electrode stack as previously described, which may include any of the components described above for battery cell 100, including any number of cells or configurations, as well as any other electrode stack materials. It is to be understood that the figure is not produced to any particular scale for any component. For example, the electrode stack may consume a majority internal volume in some embodiments, and the illustrated proportions are not intended to be limiting or necessarily representative of anything more than the structural configuration of battery cells according to some embodiments of the present technology.

The housing of battery cell 200 may include a first conductive segment 205, which may be coupled electrically with the anode current collector, such as with an anode tab 207, and may be operable at anode potential. Additionally, the housing may include a second conductive segment 210, which may be coupled electrically with the cathode current collector, such as with a cathode tab 212, and may be operable at cathode potential. It is to be understood that in some embodiments the structure may be reversed, such as by inverting the electrode stack, which may then switch the couplings and operational potentials of the housing sections, which is similarly encompassed by the present technology. A gasket 215 may be positioned between the first conductive segment and the second conductive segment and may facilitate hermetic sealing of the housing and battery cell in some embodiments. The gasket can be any number of components, such as a plastic or elastomer o-ring, a glass or ceramic feedthrough, or any other mechanism that may couple the two housing sections and may also maintain electrical isolation between the two housing sections, which may be operating at opposite potential from one another. Although the housing sections are illustrated as simply overlapping the gasket, it is to be understood that any number of couplings including crimping, welding, or other mechanical couplings, or any other type of coupling are similarly encompassed by the present technology. Accordingly, a number of housing configurations for button-cell battery cells as well as other styles of housing are similarly encompassed.

As illustrated, an electrode stack 220 may be included within the housing, and which may include any number of anodes or cathodes as previously described. The electrode stack may be a number of stacked electrodes, or may be a wound design or a folded configuration, and may be a jelly roll, layers or electrode materials, a prismatic cell stack, or any other type of cell configuration that may be incorporated within the housing. As illustrated, an electrode tab may be coupled with each of the anode and cathode, and the tab may be coupled with the housing sections. As noted above, an anode tab 207 may be coupled with first conductive segment 205 of the housing, and cathode tab 212 may be coupled with second conductive segment 210 of the housing. The coupling may be any physical or electrical coupling in some embodiments, and may be a conductive tab that may be adhered, bonded, welded, or otherwise physically coupled with the housing segment to provide electrical coupling with the associated housing segment.

In some embodiments, the first conductive segment 205 of the battery cell housing, and the second conductive segment 210 of the battery cell housing may each be characterized by a flat base and a sidewall, which may at least partially extend circumferentially about the flat base, and depending on the sidewall profile, may extend at an angle as well as orthogonally to the flat base, which may define the volume of the battery cell. The flat base of each segment of the housing may extend at least partially parallel to one another, and may extend substantially parallel to each other as well as the first section and second section of each of the anode current collector and cathode current collector, as well as each intervening planar segment as illustrated. The conductive segments may be formed of any metal, alloy, or other conductive material, such as stainless steel, or other housing materials. Additionally, the outer surfaces may be dielectric or other materials including conductive contacts for electrically coupling the battery with a device.

As shown, the first conductive segment 205 of the housing may be maintained at anode potential due to the coupling with the anode current collector, which may be cathode potential in other embodiments in a reversed orientation of the electrode stack 220. The sidewall of the first conductive segment 205 may at least partially radially define the volume of the battery cell, and may be exposed to the cathode current collector along one or more folds of the electrode stack. Although the electrode stack may be spaced to accommodate a gap, or a spacer may be positioned within the volume, this may reduce the volume occupied by the electrode stack, and may reduce energy density of the battery cell. Accordingly, in some embodiments in which a jelly roll or other wrapped configuration may be used, the outer layer of the electrode stack may be anode material, which may reduce or limit the potential for an internal short to the sidewall of the housing at anode potential. Alternatively, or in addition, the interior sidewalls of the first conductive segment 205 may be passivated or coated to limit electrical interaction with the electrode stack. Additionally, the battery cell may include an electrolyte incorporated within the housing.

As explained above, when stainless steel may be used as the housing segments, the second conductive segment 210 may be operated at cathode potential. Depending on the electrolyte material utilized within the cell, when the electrode stack is maintained in the housing without physical separation from the housing segment, a corrosion reaction may occur. However, simply incorporating a spacer between the electrode stack and the second conductive segment 210 of the housing may challenge or frustrate electrode coupling with the housing segment. This issue may be in part due to the sidewall of the second conductive segment extending radially outward of, and being at least partially blocked by, the sidewalls of the first conductive segment 205, which may at least partially define the internal volume of the battery cell. Accordingly, if the entire base of the second conductive housing segment 210 is covered by a spacer, electrical coupling may be not be feasible. The present technology may overcome this by incorporating a barrier material that may allow electrode coupling while maintaining a physical barrier between the electrode stack and the housing segment at cathode potential.

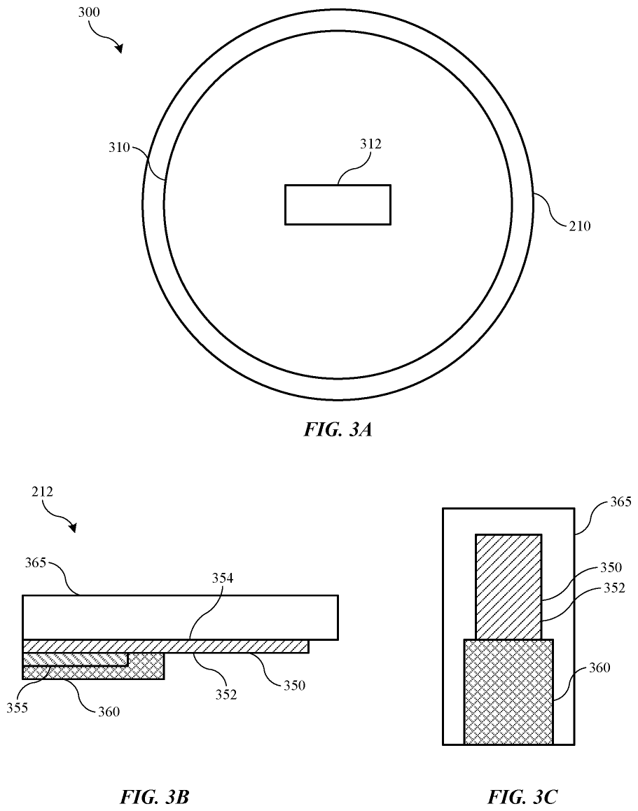

FIG. 3A shows a schematic view of battery materials 300 according to some embodiments of the present technology, which may include a barrier material for reducing or limiting corrosion of the housing segment at cathode potential. Battery materials 300 may include a top plan view of second conductive segment 210 of the housing, with the electrode stack and the first conductive segment removed. Disposed on the base of second conductive segment 210 may be a barrier material 310, which in some embodiments may be disposed at least partially between the cathode tab of the electrode stack, such as cathode tab 212 described above, and the second conductive segment 210 of the housing. The barrier material 310 may be disposed between the electrode stack and the second conductive segment of the housing, although the cathode tab may at least partially extend through, or be coupled through, the barrier material to electrically couple with the second conductive segment of the housing.

Barrier material 310 may be any number of coatings or materials that may be disposed on an interior surface of the base of second conductive segment 210. As will be explained below, in some embodiments the barrier material may be a complete coating through which welding may be performed, although in some embodiments barrier material 310 may define an aperture 312 through which the cathode tab may extend for physical and/or electrical coupling with the second conductive segment 210. Barrier material 310 may be characterized by any shape or geometry, and may be characterized by a similar shape as the second conductive segment 210, an incorporated electrode stack, or both. For example, in some embodiments the second conductive segment of the housing may be characterized by an elliptical shape, including a round shape or other arcuate shape. The barrier material 310 may similarly be characterized by an outer radius, which may be less than an inner radius of the second conductive segment 210, and may be a dimension less than the inner radius of the sidewall of the first conductive segment to limit interaction between the components, which may affect sealing of the housing.

The barrier material may be characterized by an annular shape in some embodiments, and may define an interior aperture 312 at an interior diameter or within the barrier material structure. Although shown as centrally located, it is to be understood that the aperture through which the cathode tab may extend may be located at any position within the structure, such as with a tab that is offset from center. The aperture may also be characterized by any shape or geometry, including rectangular as illustrated, elliptical, or oblong in one or more dimensions to facilitate access for the cathode tab. When centrally located, the aperture 312 may at least partially define an inner annular radius of the barrier material 310. Although the aperture may be characterized by any dimensions, as will be explained below, in some embodiments the aperture may be characterized by dimensions allowing the aperture to be partially or completely covered.

The barrier material may be characterized by any number of materials, which may not react or interact with materials of the electrolyte or electrode active materials of the electrode stack. For example, the barrier material may include any number of polymeric materials and/or adhesive materials, including adhesive on one side of the barrier material, such as facing the second conductive housing segment, which may allow the barrier material to bind with the segment. The adhesives may be or include a polymer backing with an applied adhesive. The polymer may be any number of polymers that provide electrical resistivity, structural resiliency, hydrophobicity, or flexibility. For example, in some embodiments a polyimide-backed tape may be used, which may afford a thin film tape that may be flexible and may be relatively or fully inert to reaction with components of the electrolyte. Although described as a tape, additional adhesives or encapsulants may be utilized to provide a similar protection for the second conductive segment of the housing, and are similarly encompassed by the present technology.

The barrier material may provide a physical barrier for the materials within the battery cell, and may limit interaction with the second conductive segment of the housing, which may limit corrosion when operated at cathode potential. The aperture through the barrier material, when included, may produce an additional access path allowing corrosion to occur.

Accordingly, in some embodiments the aperture may be at least partially or fully covered by aspects of the cathode tab, or associated components. Turning to FIG. 3B is shown a schematic view of battery materials according to some embodiments of the present technology, and may illustrate aspects of a cathode tab 212 as previously explained. The cathode tab 212 may extend from a cathode current collector or electrode as previously explained, and may allow for coupling with the second conductive segment of the housing.

The cathode tab 212 may include an actual tab element 350, and which may be any of the materials that may be used for cathode current collectors, and may be the same or a compatible material with the cathode current collector 355 and/or the material of the second conductive segment of the housing. The tab element 350 may be characterized by a first surface 352 and a second surface 354, which may be opposite the first surface. First surface 352 may be configured to be coupled with the second conductive segment of the housing, and may include an exposed portion as illustrated. In some embodiments, the conductive tab may be welded or bonded with the cathode current collector 355. Although illustrated as being coupled on the first surface 352 of the tab element 350, it is to be understood that the cathode tab may be coupled with a current collector on either side of the tab element. To limit sharp or jagged edges of features, one or more insulation tapes or adhesives may be used to cover the tab element 350. A first insulative material 360 may be disposed in contact with the first surface of the tab element 350, and may extend partially along the first surface of the cathode tab. The first insulative material may not fully cover the tab element as illustrated, which may allow a region of the tab element to be exposed for welding or bonding with the housing segment. Accordingly, and as will be explained below, the first insulative material 360 may be disposed adjacent to or in contact with the barrier material.

The cathode tab 212 may also include a second insulative material 365, which may protect the second surface 354 of the cathode tab element 350. The second insulative material may be disposed in contact with the second surface 354 of the tab element, and may extend at least partially along the second surface of the cathode tab. The second insulative material may afford additional protections, and may be used to limit contact or interaction between the electrode stack and the cathode tab, and may also be used in some embodiments of the present technology to at least partially cover the aperture in the barrier material, when formed. The first insulative material 360 and the second insulative material 365 may be any number of materials in some embodiments, and may be the same or a different material from the barrier material. For example, in some embodiments the insulative materials may also be adhesive polymeric materials, such as polyimide-backed adhesive tapes, and the adhesive may extend in contact with the tab element 350.

FIG. 3C shows a schematic view of battery materials according to some embodiments of the present technology, and may show an additional view of the cathode tab 212 in a direction facing the first insulative material 360. As illustrated, cathode tab element 350 may be exposed along first surface 352 from first insulative material 360, which may extend along the first surface, while exposing a contact surface allowing coupling with the second conductive segment of the housing. Additionally, second insulative material 365 may extend along the second surface of the tab element 350. In some embodiments, the second insulative material 365 may extend beyond the lateral edges of one or more surfaces of the tab element 350, and may extend beyond the lateral dimensions of the exposed portion of the tab element 350 in all directions as illustrated. In some embodiments, this may allow the second insulative material 365 to contact the barrier material externally to the cathode tab.

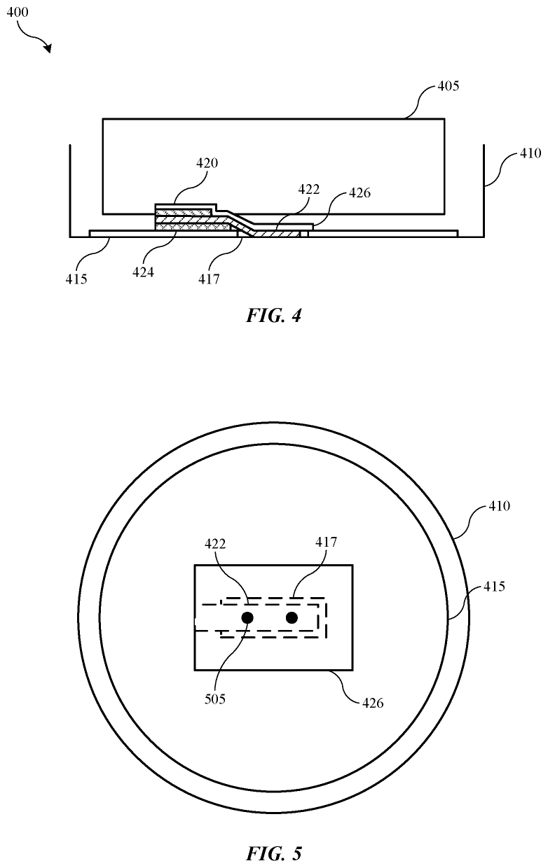

FIG. 4 shows a schematic cross-sectional elevation view of battery materials according to some embodiments of the present technology, and may show a partial view of a battery cell 400 incorporating a barrier material. Battery cell 400 may include any of the features, components, or aspects of any battery cell or component previously described, and may illustrate an electrode stack 405 incorporated within a second conductive housing segment 410. It is to be understood that any of the other components as previously described may be incorporated in some embodiments of the present technology, such as to produce a button-cell battery, among any other battery cell structure.

As illustrated, battery cell 400 may include a barrier material 415, which may be any of the barrier materials discussed previously, and which may be disposed along an interior surface of the second conductive segment 410 of the housing. The barrier material 415 may extend radially outward of an exterior radius of the electrode stack 405, which may further limit direct access between the electrode stack and the second conductive segment 410 of the housing. In some embodiments, barrier material 415 may define an aperture 417 through the barrier material 415, although in some embodiments a bonding operation may be performed directly through the barrier material. A conductive tab 420, which may be similar to conductive tab 212 described previously, and may include any of the components noted above, may extend from electrode stack 405 and couple a tab element 422 of the conductive tab 420 with the second conductive segment of the housing, such as along a first surface of the tab element 422 as described above. The tab element 422 may at least partially extend within the aperture 417, and a welding, bonding, or other coupling operation may be performed to physically and/or electrically couple the tab element 422 with the housing section.

A first insulative material as previously described may or may not extend into or over the aperture 417 in some embodiments, and may sit in contact with barrier material 415. In some embodiments first insulative material 424 may be a double-sided adhesive material, which may allow the material to be adhered with both of the tab element 422 as previously described, as well as with the barrier material 415 in some embodiments. Additionally, second adhesive material 426 may at least partially extend over or about aperture 417 of the barrier material, which may limit direct access with the second conductive segment 410, and which may reduce or limit corrosion of the surface. Because the same surface of the second insulative material 426 may contact each of the tab element 422 as well as the barrier material 415, the same adhesive surface may contact and adhere with both components.

FIG. 5 shows a schematic view of battery materials according to some embodiments of the present technology, and may illustrate a top view of battery cell 400 with the electrode stack 405 removed from view. As shown, barrier material 415 may be included on an interior surface of the second conductive segment 410 of the housing. As shown in hidden view beneath the cathode tab, an aperture 417 may be formed, and through which a tab element 422 may at least partially extend. The tab element 422 may be welded or bonded with the second conductive segment of the housing, such as at one or more locations 505. A second insulative material 426 may extend over the aperture 417 and the tab element 422, which may cover or block any direct access to the surface of second conductive segment 410, with which the tab element may be coupled. As noted above, second insulative material 426 may be an adhesive material, which may allow the material to be adhered with the barrier material 415 external to the lateral edges of the tab element with which the material is also adhered. This may further ensure a more complete barrier in some embodiments.

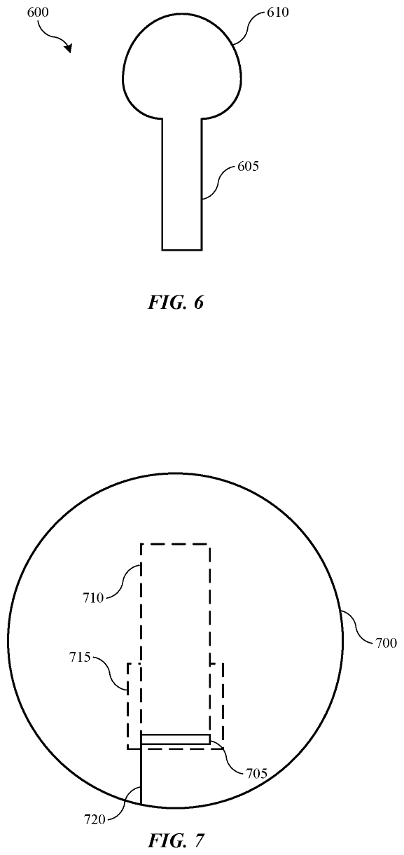

FIG. 6 shows a schematic view of an insulative material 600 according to some embodiments of the present technology, and may illustrate a variation on second insulative materials discussed previously. It is to be understood that insulative material 600 may be any of the second insulative materials discussed above. As noted previously, an aperture formed through the barrier material may be characterized by any shape or geometry according to embodiments encompassed by the present technology. In some embodiments, a portion of the second insulative material may be shaped similarly to the aperture, which may facilitate coverage of the aperture in some embodiments. For example, insulative material 600 may be characterized by a body 605 and an end region 610. Body 605 may be sized to accommodate a width of the tab element of the conductive tab, and may be sized to extend an amount laterally outward of the tab element to provide protection from the edges of the tab. End region 610 may be shaped to accommodate the aperture defining an inner annular radius of the barrier material. The end region may be characterized by a similar shape as the aperture, and/or may be shaped or sized to easily extend over the aperture to block a path between the electrode stack and the interior surface of the conductive segment of the housing. Insulative material 600 is included as one example of the many variations or geometries of insulative materials encompassed by the present technology, which may be any size or shape in embodiments.

In some embodiments of the present technology, the barrier material may be or encompass the second insulative material as previously described. For example, in some embodiments the barrier material may be sized or shaped to encompass the cathode tab as well as extend outward beyond an exterior edge of the electrode stack. Accordingly, while encompassing the cathode tab, the barrier material may be disposed between the electrode stack and the second conductive segment of the housing. FIG. 7 shows a schematic view of a barrier material 700 according to some embodiments of the present technology, which may include a barrier material that additionally operates as the second adhesive material as previously described. Battery cells incorporating barrier material 700 may include any feature, component, or characteristic as previously described.

As shown, barrier material 700 may encompass and extend over a tab element 710 of a conductive tab, which may otherwise include any aspect of the technology as previously described. As noted above, barrier material 700 may still reside between the electrode stack and the housing of the battery cell, and to accommodate fabrication, barrier material 700 may include one or more additional features. For example, barrier material 700 may define an aperture 705 through which the tab element 710 of the cathode tab may extend, or in some embodiments through which an uncoated section of the current collector may extend, and with which the tab element 710 may be coupled. In some embodiments, the configuration may still include a first insulative material 715, which may protect a weldment or coupling between the tab element 710 of the conductive tab and the cathode current collector of the battery stack. Barrier material 720 may also include a break, slit, or separation, which may allow barrier material 720 to be fitted around the cathode current collector and then coupled with the cathode tab.

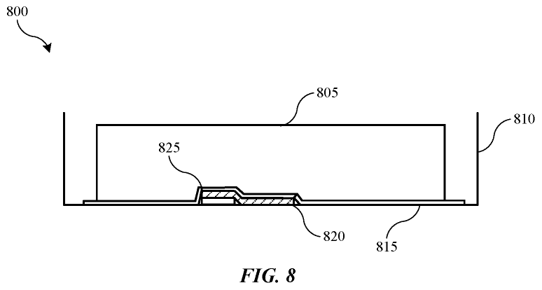

FIG. 8 shows a schematic partial cross-sectional elevation view of a battery cell 800 according to some embodiments of the present technology, and which may include barrier material 700 as previously described. It is to be understood that any of the additional battery cell components as discussed above may also be included in battery cell 800, along with any feature, component, or characteristic as previously described. For example, an electrode stack 805 may be disposed within a housing that may include a second conductive segment 810 as previously described. A barrier material 815 may be included in the structure to limit corrosion as discussed above. The electrode stack may include a cathode tab, including a tab element 820, which may be disposed on a backside of the barrier material 815. Put another way, an adhesive surface of barrier material 815, when included, may couple with both the interior surface of the second conductive segment of the housing, as well as a second surface of the tab element as described previously. The barrier material may define a slot or separation 825, which may allow the barrier material to be extended about the tab element, and also to be positioned between the electrode stack 805 and the cathode tab and/or the second conductive segment of the housing. By utilizing any number of features or components according to embodiments described above, the present technology may limit or prevent corrosion along exposed regions of the conductive housing, while maintaining a coupling location for a cathode tab.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A rechargeable battery cell comprising:
a housing comprising:
a first conductive segment operable at anode potential,
a second conductive segment operable at cathode potential, and
a gasket positioned between the first conductive segment and the second conductive segment and configured to hermetically seal the housing;
an electrode stack comprising:
an anode, wherein the anode comprises an anode tab electrically coupled with the first conductive segment of the housing,
a cathode, wherein the cathode comprises a cathode tab electrically coupled with the second conductive segment of the housing; and
a barrier material disposed at least partially between the cathode tab and the second conductive segment of the housing, wherein the cathode tab is electrically coupled with the second conductive segment of the housing through the barrier material.

2. The rechargeable battery cell of claim 1, wherein the second conductive segment is stainless steel.

3. The rechargeable battery cell of claim 1, wherein the barrier material is characterized by an annular shape, and wherein the cathode tab is coupled with the second conductive segment of the housing at an aperture defining an inner annular radius of the annular shape of the barrier material.

4. The rechargeable battery cell of claim 3, wherein the aperture is characterized by an elliptical or rectangular shape.

5. The rechargeable battery cell of claim 3, wherein the cathode tab is characterized by a first surface coupled with the second conductive segment of the housing, and a second surface opposite the first surface, the rechargeable battery cell further comprising:
a first insulative material in contact with the first surface of the cathode tab and extending partially along the first surface of the cathode tab.

6. The rechargeable battery cell of claim 5, wherein the first insulative material is positioned adjacent the barrier material.

7. The rechargeable battery cell of claim 5, further comprising:
a second insulative material in contact with the second surface of the cathode tab and extending partially along the second surface of the cathode tab.

8. The rechargeable battery cell of claim 7, wherein the second insulative material extends beyond lateral edges of the cathode tab, and wherein the second insulative material contacts the barrier material externally to the cathode tab.

9. The rechargeable battery cell of claim 8, wherein the second insulative material covers the aperture defining the inner annular radius of the barrier material.

10. The rechargeable battery cell of claim 9, wherein the second insulative material is characterized by an end region shaped to cover the aperture defining the inner annular radius of the barrier material.

11. The rechargeable battery cell of claim 7, wherein the barrier material, the first insulative material, and the second insulative material each comprise a similar material.

12. The rechargeable battery cell of claim 11, wherein the similar material is an adhesive polymeric material.

13. A rechargeable battery cell comprising:
a button-cell housing comprising:
a first conductive segment,
a second conductive segment, and
a gasket positioned between the first conductive segment and the second conductive segment and configured to seal the button-cell housing;
an electrode stack comprising:
an anode,
a cathode, wherein the cathode comprises a cathode tab physically and electrically coupled with the second conductive segment of the housing; and
a barrier material disposed at least partially between the cathode tab and the second conductive segment of the button-cell housing, wherein the cathode tab extends through the barrier material and physically and electrically couples with the second conductive segment of the housing.

14. The rechargeable battery cell of claim 13, wherein the barrier material is a material comprising an adhesive surface, and wherein the adhesive surface extends in contact with the second conductive segment of the button-cell housing.

15. The rechargeable battery cell of claim 14, wherein the barrier material is characterized by an annular shape, and wherein the cathode tab is coupled with the second conductive segment of the housing at an aperture defining an inner annular radius of the annular shape of the barrier material.

16. The rechargeable battery cell of claim 15, wherein the cathode tab is characterized by a first surface coupled with the second conductive segment of the housing, and a second surface opposite the first surface, the rechargeable battery cell further comprising:
a first insulative material in contact with the first surface of the cathode tab and extending partially along the first surface of the cathode tab.

17. The rechargeable battery cell of claim 16, wherein the first insulative material is a material comprising an adhesive surface, wherein the adhesive surface extends in contact with the cathode tab, and wherein a surface of the first insulative material opposite the adhesive surface extends in contact with the barrier material.

18. The rechargeable battery cell of claim 16, further comprising:
a second insulative material in contact with the second surface of the cathode tab and extending partially along the second surface of the cathode tab.

19. The rechargeable battery cell of claim 18, wherein the second insulative material is a material comprising an adhesive surface, wherein the adhesive surface extends in contact with the cathode tab, and wherein an edge region of the adhesive surface contacts the barrier material.

20. A rechargeable battery cell comprising:
a housing comprising:
a first conductive segment operable at anode potential,
a second conductive segment operable at cathode potential, and
a gasket positioned between the first conductive segment and the second conductive segment and configured to hermetically seal the housing;
an electrode stack comprising:
an anode, wherein the anode comprises an anode tab electrically coupled with the first conductive segment of the housing,
a cathode, wherein the cathode comprises a cathode tab electrically coupled with the second conductive segment of the housing, and wherein the cathode tab is characterized by a first surface coupled with the second conductive segment of the housing, and a second surface opposite the first surface; and
a barrier material encompassing the cathode tab and disposed between the electrode stack and the second conductive segment of the housing, wherein the cathode tab is electrically coupled with the second conductive segment of the housing through the barrier material.
